(19) United States
(12) Patent Application Publication
(10) Pub. No.: US 2014/0338151 A1
(43) Pub. Date: Nov. 20, 2014

(54) AUTOMATIC DOOR CONTROLLER AND DOOR ACTUATION EQUIPMENT

(71) Applicant: Magna Closures Inc., Newmarket (CA)

(72) Inventors: John Robert Scott Mitchell, Newmarket (CA); Jeffrey Richard F. Domenchini, Etobicoke (CA); John Clark, Maple (CA); James Joseph Ferri, Maple (CA); Ilya Neyman, Thornhill (CA); Csaba Szente, Newmarket (CA); Samuel R. Baruco, Aurora (CA)

(21) Appl. No.: 14/448,200

(22) Filed: Jul. 31, 2014

Related U.S. Application Data
(63) Continuation of application No. PCT/CA2013/000138, filed on Feb. 15, 2013.
(60) Provisional application No. 61/600,294, filed on Feb. 17, 2012.

(30) Foreign Application Priority Data
Feb. 15, 2013 (CA) PCT/CA2013/000138

(51) Int. Cl. E05F 1/00; E05D 7/00

(52) U.S. Cl. CPC E05F 1/002; E05D 7/00
USPC 16/223

(57) ABSTRACT

An actuated hinge assembly for facilitating pivoting movement of a door, the hinge assembly including: a first hinge member; a second hinge member pivotally coupled to the first hinge member; a powered actuator operatively coupled to the first hinge member, the actuator configured to drive relative rotation of the first hinge member and the second hinge member with respect to each other; wherein one hinge of the first hinge member and the second hinge member is configured for mounting to the door and the other of the first hinge member and the second hinge member is configured for mounting to a door frame of the door. Also included is a controller unit configured to control actuation of a powered latch assembly and/or the actuated hinge assembly using control signals received from a transponder.

### FIELD

The present invention relates to automatic doors.

### BACKGROUND

Current powered doors provide for bulky door actuation mechanisms with which to open and close the door automatically due to activation of a wall mounted switch. Disadvantages with this design include increased door installation costs related to attachment of the door actuation mechanism between the door and doorframe, as well required space available adjacent to the door (typically overhead) for the door actuation mechanism itself.

Also, the need for installation of wall switches, for automatic operation of current doors by the user, is also a disadvantage with current automatic door designs. Further, the ability for the user to control desired manual and/or automatic operation of their own door in an individual setting is also problematic, as current automatic door systems are typically configured and controlled centrally by a security or buildings operation department for arger buildings and commercial centers.

### SUMMARY

It is an object to the present invention to provide an automatic door component configured to obviate or mitigate at least one of the above-mentioned problems.

A first aspect provided is an actuated hinge assembly for facilitating pivoting movement of a door, the hinge assembly including: a first hinge member; a second hinge member pivotally coupled to the first hinge member; a powered actuator operatively coupled to the first hinge member, the actuator configured to drive relative rotation of the first hinge member and the second hinge member with respect to each other; wherein one hinge of the first hinge member and the second hinge member is configured for mounting to the door and the other of the first hinge member and the second hinge member is configured for mounting to a door frame of the door.

A second aspect provided is a controller unit for operating a door assembly including a door, a hinge assembly having a pair of hinge members for connecting the door to an adjacent door frame and including a hinge actuator for driving relative movement of the hinge members with respect to each other, and a latch assembly including a latch element and a latch actuator configured to operate a position of the latch element between an extended position and a retracted position, the controller unit including: a processor; a receiver for receiving a door operation signal from a transponder; and a set of instructions stored in a physical memory for execution by the processor to: receive the door operation signal from the transponder; authenticate that the transponder is registered with the controller unit; transmit a first actuation signal to the hinge actuator and a second actuation signal to the latch actuator in order to cause said relative movement to either displace the door from a closed position to an open position or from the open position to the closed position.

A third aspect provided is a controller unit for operating a door assembly including a door, a hinge assembly having a pair of hinge members for connecting the door to an adjacent door frame, and a latch assembly including a latch element and a latch actuator configured to operate a position of the latch element between an extended position and a retracted position, the controller unit including: a processor; a receiver for receiving a door operation signal from a transponder; and a set of instructions stored in a physical memory for execution by the processor to: receive the door operation signal from the transponder; authenticate that the transponder is registered with the controller unit; transmit a second actuation signal to the latch actuator in order to operate the position of the latch element towards the retracted position providing for displacement of the door from a closed position to an open position or from the open position to the closed position.

A fourth aspect provided is a controller unit for operating a door assembly including a door, a hinge assembly having a pair of hinge members for connecting the door to an adjacent door frame, and a latch assembly including a latch element and a latch actuator configured to operate a position of the latch element between an extended position and a retracted position, the controller unit including: a processor; a receiver configured for receiving a door operation signal from a manually actuated switch associated with the door; and a set of instructions stored in a physical memory for execution by the processor to: when receiving the door operation signal, transmit a second actuation signal to the latch actuator in order to operate the position of the latch element towards the retracted position providing for displacement of the door from a closed position to an open position or from the open position to the closed position.

### BRIEF DESCRIPTION OF THE DRAWINGS

The foregoing and other aspects will be more readily appreciated having reference to the drawings, wherein:

FIG. 1a is a side view of a door assembly;

FIG. 1b is a top view of the door assembly of FIG. 1a;

FIG. 2 is a side view of an example actuated hinge assembly of FIG. 1a;

FIG. 3 is a further side view of the actuated hinge assembly of FIG. 2;

FIG. 4 is a further side view of the actuated hinge assembly of FIG. 2;

FIG. 5 is an alternative embodiment of the actuated hinge assembly of FIG. 2;

FIG. 6 is a further alternative embodiment of the actuated hinge assembly of FIG. 2;

FIG. 7 is a cross sectional view of an example latch assembly of the door assembly of FIG. 1a;

FIG. 8 is a perspective external view of the latch assembly of the door assembly of FIG. 7;

FIG. 9 shows a system diagram of a controller unit and coupled control devices for the door assembly of FIG. 1a;

FIG. 10 is a flowchart showing an example operation of the control system of FIG. 9;

FIGS. 11a,b,c,d show alternative operational examples of the control system of FIG. 9;

FIG. 12 shows an example flowchart of program instructions for the controller unit of FIG. 9;

FIG. 13 shows an example flowchart of program instructions for a transponder in communication with the controller unit of FIG. 9; and

FIG. 14 is a still further alternative embodiment of the actuated hinge assembly of FIG. 2.

### DETAILED DESCRIPTION OF THE PREFERRED EMBODIMENTS

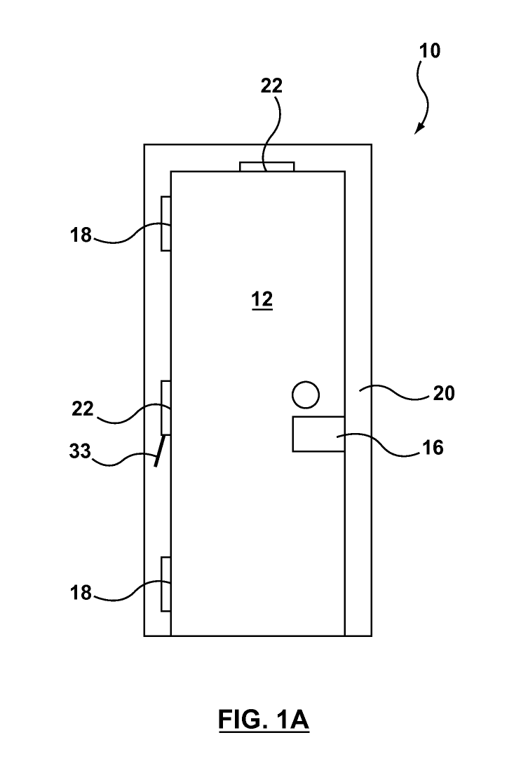

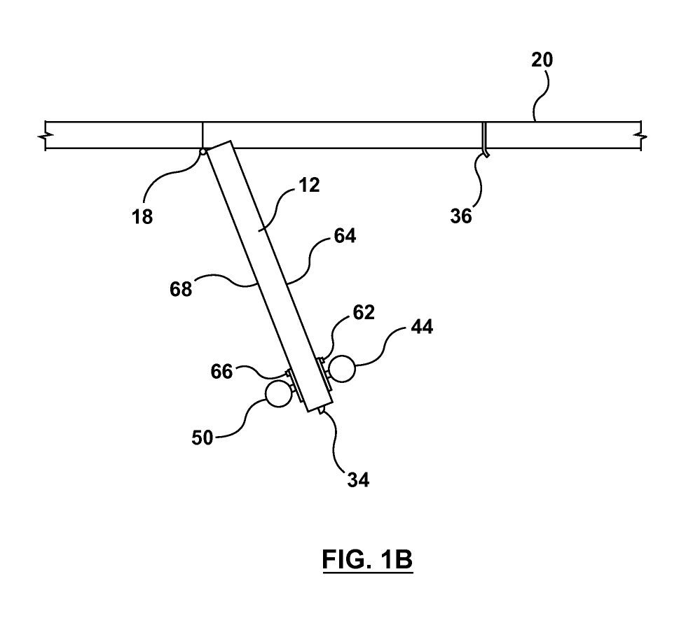

Reference is made to FIG. 1, which shows a door assembly 10 in accordance with an embodiment of the present invention. The door assembly 10 can includes a door 12, a doorframe 20, a door actuator 14 and/or a door latch 16. The door 12 may be made from any suitable material such as wood. The door assembly 10 may include one or more support hinges 18 that mount between the door 12 and the door frame 20 to support the door 12 thereon for pivoting movement of the door 12 about an axis A between a closed position (FIG. 1) and an open position (FIG. 1b). The door actuator 14 may be contained in an actuator hinge 22 that is aligned with the support hinges 18 for pivoting movement of the door 12 about axis A. It is recognized that one example of the actuator hinge 22 can be defined as a type of bearing that connects two solid objects (e.g. door and door frame), typically allowing only a limited angle of rotation between them, such that the objects connected by the actuator hinge 22 rotate relative to each other (e.g. pivot) about their fixed axis of rotation. Alternatively, the actuator hinge 22 can be defined including an actuator mounted on the door frame 20 above the door 12 and coupled to a linkage assembly (e.g. a two arm linkage connected to both the door 12 and the doorframe 20, including a pivot hinge at the connection between the two arms—not shown) that connects the actuator to the door 12 proximate to the top of the door 12, thus providing for movement/displacement of the door 12 with respect to the doorframe 20. In either example, it is recognized that the door 12 can have one or more support hinges 18 in addition to the actuator hinge 22, as the actuator hinge 22 is configured to provide connection between the door 12 and doorframe 20 as well as actuation of the door 12 between an open and closed position. In this manner, operation of the actuator hinge 22 facilitates displacement of the door 12 with respect to the door frame 20 and as such helps to control ingress/egress of a person for a room in a building (or the building itself).

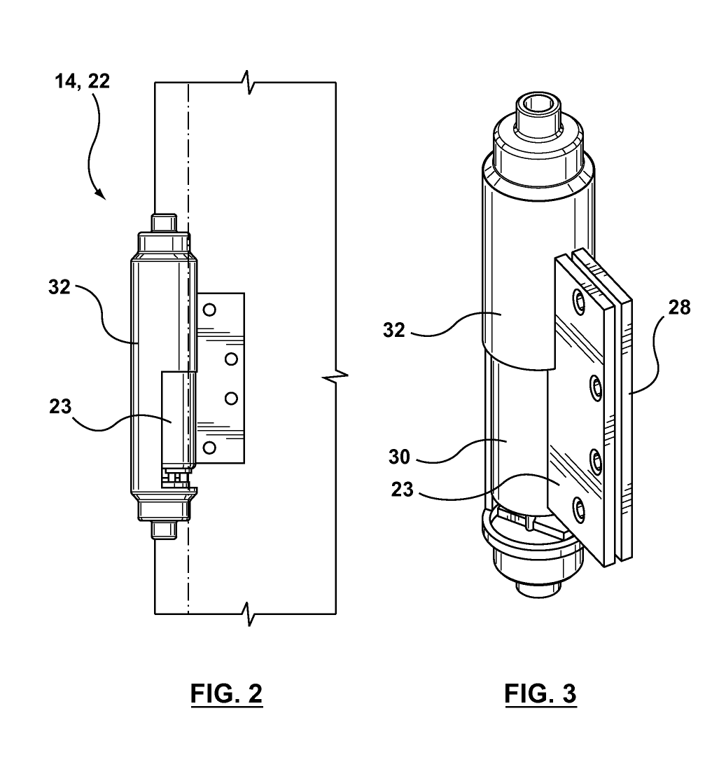

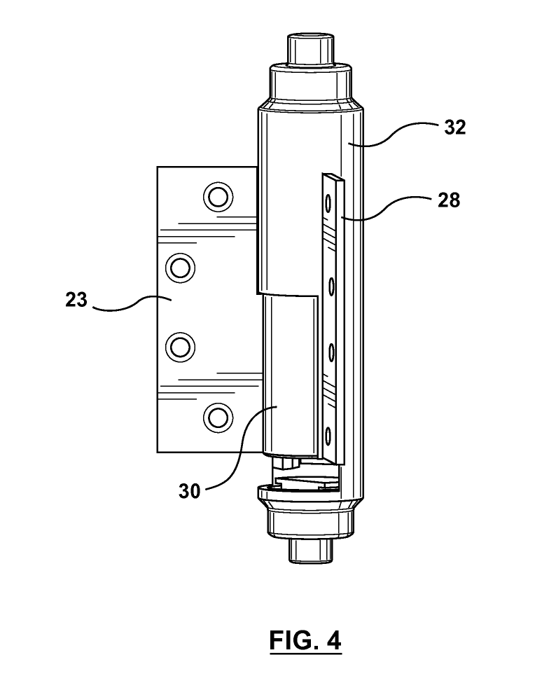

Referring to FIGS. 2, 3, 4, 5 and 6, the actuator hinge 22 may be configured to support some of the weight of the door 12, or alternatively it may not be configured to support any significant amount of weight vertically, instead relying on the one or more support hinges 18 for that purpose. The actuator hinge 22 includes a first hinge member 23, a powered actuator 24 (e.g. electric motor), operative coupling of the powered actuator 24 to the hinge member(s)—an example of which could be a gear set 26 (which in this exemplary embodiment is a planetary gearset), and a second hinge member 28 coupled to the first hinge member 23. As such, the actuated hinge 22 assembly can facilitate pivoting movement of the door 22, such that the second hinge member 28 is pivotally coupled to the first hinge member 23. The powered actuator 24 is operatively coupled to the first hinge member 23, such that the powered actuator 24 is configured to drive relative rotation of the first hinge member 23 and the second hinge member 28 with respect to each other. It is recognized that one hinge of the first hinge member 23 and the second hinge member 28 is configured for mounting to the door 12 and the other of the first hinge member 23 and the second hinge member 28 is configured for mounting to the door frame 20 of the door 12.

For example, the first hinge member 23 is preferably mountable to the door 12, and can include a housing portion 30 that houses the powered actuator 24. The gear set 26 transfers power from the powered actuator 24 to the second hinge member 28 (and can therefore be said to be operatively connected to the second hinge member 28), which is, in this embodiment, connected to the doorframe 20. The second hinge member 28 can itself include a sleeve portion 32 that slides over the housing portion 30 of the first hinge member 23 and is supported thereon. Suitable thrust bearings or the like (not shown) can be provided as needed to assist in supporting some axial loading in the actuator hinge 22 (e.g. from the weight of the door 12). Operation (e.g. rotation) of the powered actuator 24 drives relative rotation of the first 23 and second hinge 28 members with respect to each other. While the powered actuator 24 is shown as being mounted to the first hinge member 23 and the gearset 26 is operatively connected to the second hinge member 28, it is alternatively possible to mount the powered actuator 24 to the second hinge member 28 and to have the gear set 26 be operatively connected to the first hinge member 23.

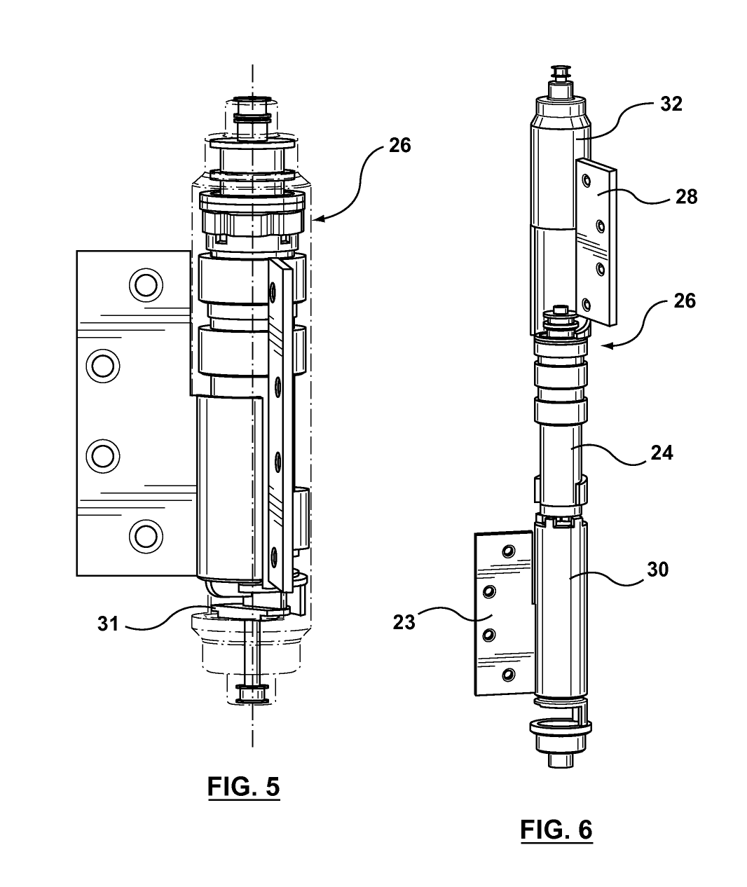

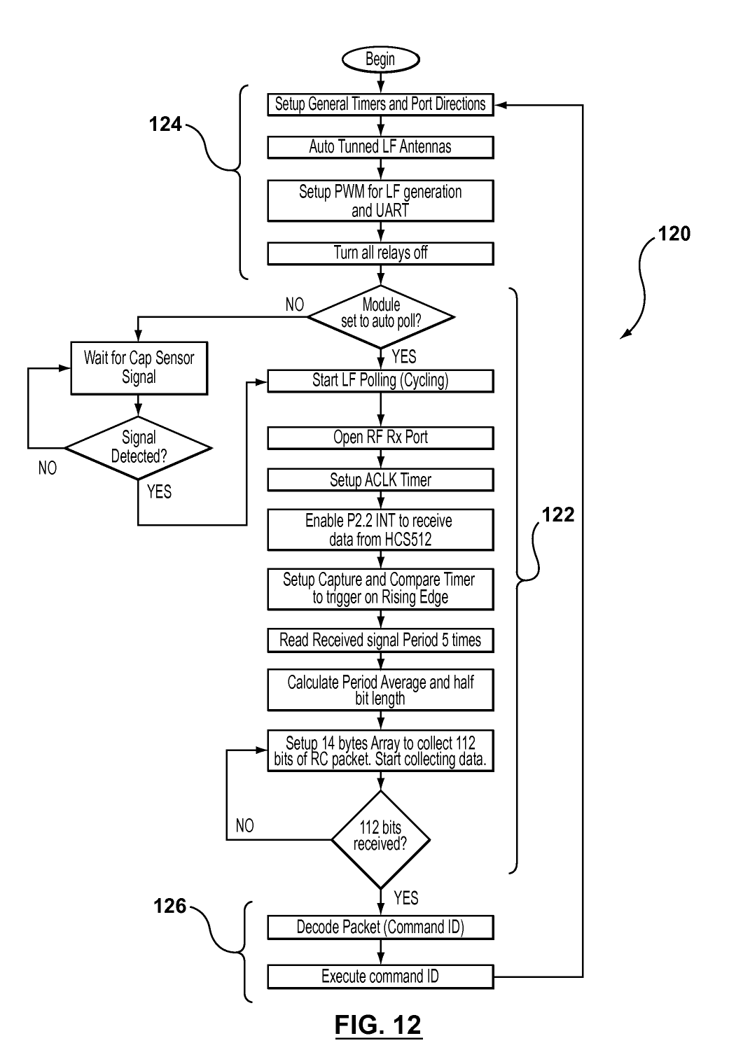

A door controller unit 31 (FIG. 5) can be provided for controlling the operation of the powered actuator 24. Power may be transmitted to the controller unit 31 (in the case where the controller 31 is in the door 12 or otherwise mounted on the actuator hinge 22) for its operation and/or for operation of the powered actuator 24 through power conduits 33 (e.g. wires) (FIG. 1a) that can extend from the doorframe 20 axially upwards through the bottom of the housing portion 30. Further, the first hinge member 23 can have the power conduit 33 connected to the powered actuator 24, whereby the power conduit 33 is configured for coupling to an external power source (e.g. power outlet—not shown) located off of the door 12 and adjacent to the door frame 20. Alternatively, the second hinge member 28 can have a passageway for directing the power conduit 33 into the door frame 20. Alternatively, as shown in FIG. 12, the controller unit 31 can be located off of the actuator hinge 22 and located inside or otherwise attached to the door 12 itself. Alternatively, the controller unit 31 can be positioned in room/building adjacent to the doorframe 20 or otherwise situated remotely from the door 12.

By providing the actuator in the form of the actuator hinge 22, advantageously one can replace a support hinge 18 that would normally be provided on a typical door 12. As such, the mounting of the door 12 to the doorframe 20 can use little additional work as compared to the mounting of a typical prior art door that is not actuated. Furthermore, there can be significantly less visual clutter associated with the motorized door assembly 10 as compared to motorized doors that include a motor assembly mounted on the door frame above the door with a linkage that connects the motor assembly to the door proximate the top of the door.

In terms of the actuated hinge 22 assembly, the gear set 26 (when driven by the powered actuator 24) provides output torque applied to the respective (e.g. second) hinge member, such that the output torque can be collinear with a pivot axis of the actuated hinge 22 assembly. As such, the application of the torque from the gear set is directed along the pivot axis line of the actuated hinge 22 assembly (e.g. axis 18), thereby helping to provide for a compactly packaged actuated hinge 22 assembly. For example, the axis of ration of the gear set is in line (e.g. collinear) with the pivot axis of the actuated hinge 22 assembly.

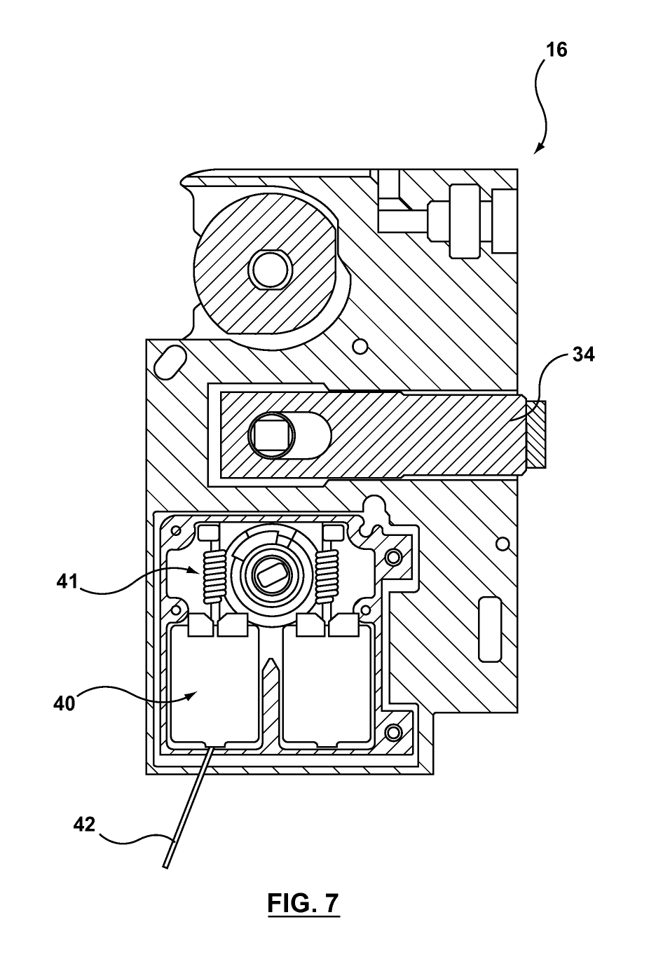

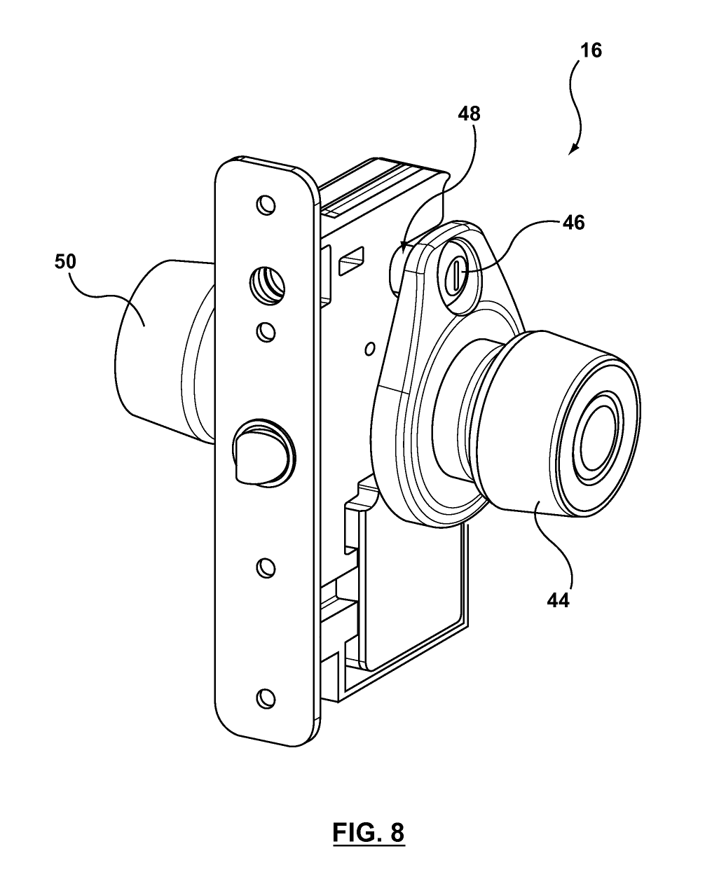

In terms of other components of the door assembly 10, the door latch 16 of the door 12 is shown by example in FIG. 7. In a preferred embodiment, the door latch 16 includes a latching element 34 (FIG. 1b) which can, for example, be a deadlatch that engages a strike plate 36 on the door frame 20, a latch actuator (e.g. motor) 40, a an optional latch controller 41 that receives power from wires 42 (e.g. power conduit) and can controls the operation of the latch actuator 40. The wires 42 can draw power from the wires 33 that transmit power to the powered actuator 24 for the actuator hinge assembly 22. Alternatively, the latch actuator 41 can be embodied as part of the controller unit 31 shown in FIG. 12 that can be located off of the door latch 16 and located inside or otherwise attached to the door 12 itself. Alternatively, the controller unit 31 (with incorporated latch controller 41) can be positioned in the room/building adjacent to the doorframe 20 or otherwise situated remotely from the door 12.

As such, the door 12 has the door latch 16 including the latching element 34 and the latch actuator 38 configured to operate a position of the latch element 34 between an extended position and a retracted position. The latching element 34 when in the extended position is configured to be received by a receptacle (e.g. striker plate 36) in the door frame 20 to retain the door 12 in the closed position, such that the actuator hinge 22 assembly and the door latch 16 and the door 12 can be provided as the door assembly 10.

Further, the latch assembly 16 can include a mechanical override mechanism for operating the position of the latch element 34 towards the retracted position without operation of the latch actuator 40 by the second actuation signal 76. For example, the mechanical override mechanism can be a door handle 44,50 coupled to the latch element 34. Alternatively, the override mechanism can be a key cylinder 46 coupled to the latch element. Other door assembly 10 components can include the door handle 44 (e.g. on one side of the door 12). The door handle 44 can include the key cylinder 46 that can receive a key. When the key (not shown) is inserted into the slot in the key cylinder 46, the cylinder 46 can be rotated, thereby rotating a cam member 48 that mechanically actuates the latch element 34. Thus the key cylinder 46 (or coupled handle 44,50) can provide a mechanical or manual backup for operating the latch element 34 in the event of a power failure (e.g. power is not available via power conduits 33, 42). A door handle 50 can also be provided on the other side of the door 12 and similarly, the door handle 50 can be used to operate the latch element 34 in the event of a power failure (e.g. power is not available via power conduits 33, 42).

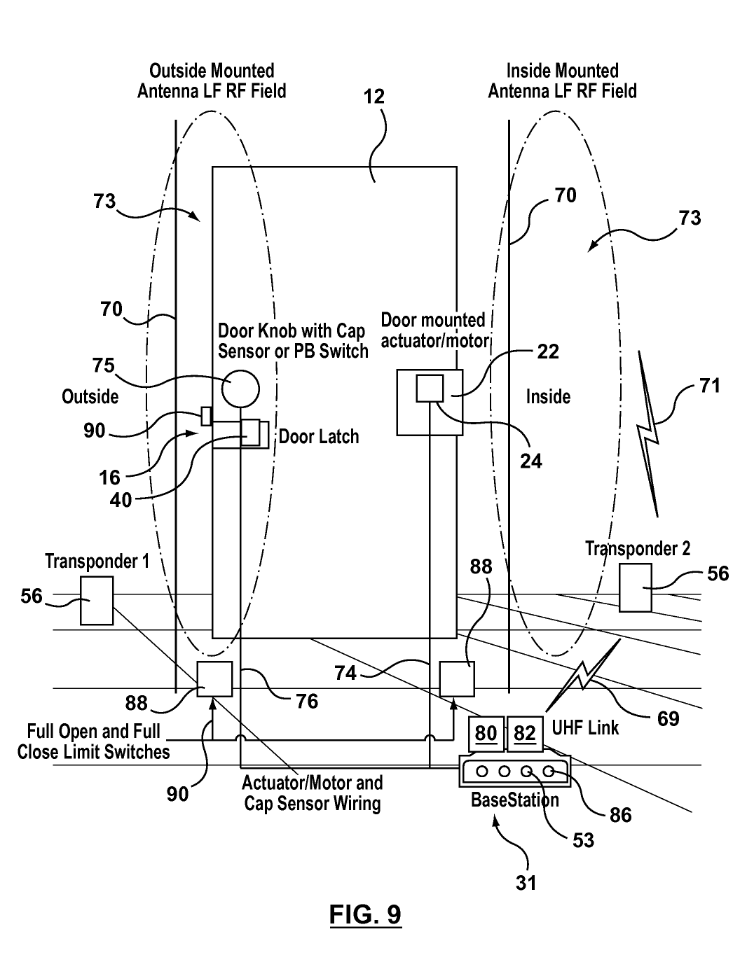

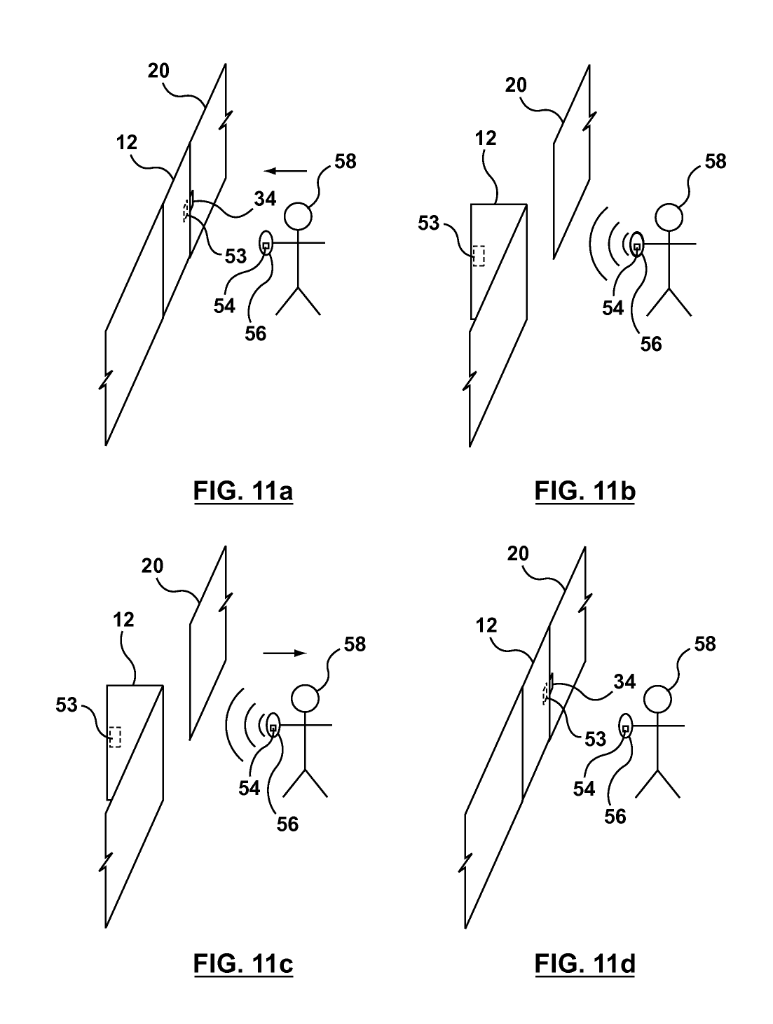

Referring to FIGS. 9 and 11a,b,c,d, the displacement of the door 12 relative to the door frame 20 (see FIG. 1a) can be controlled by the controller unit 31, which can be programmed to operate the door latch 16 and the actuator hinge 22 automatically, dependent upon signals 69 received from transponders 56 (e.g. key fob) and/or a manual switch 75. As such, the controller unit 31 can be configured to respond and transmit actuation signals 74,74 (see below) based on polling for transponders 56 in range of the controller unit 31 and/or transmitters 70, and/or by activating the manual switch 75 located on or adjacent to (e.g. on the wall or doorframe 20) the door 12.

For example, the receiver 53 can be configured to receive the door operation signal 69 from the transponder 56 rather than from the manual switch 75 before transmitting the second actuation signal 76. Alternatively, the receiver 53 can be configured to receive the door operation signal 69 from the manual switch 75 rather than from the transponder 56 before transmitting the second actuation signal 76. Alternatively, the manual switch 75 can be configured to send the second actuation signal 76 directly to the latch actuator 40 directly rather than indirectly through the receiver 53.

In terms of usage of the manual switch 75 to cause operation of the latch element 34 towards the retracted position, the controller unit 31 can be placed into a first state or a second state. The first state provides for operation of the latch element 34 as dependent upon receipt of the second actuation signal 76 by the latch actuator 40. Alternatively, the second state provides for operation of the latch element 34 as independent of latch actuator 40 operation, and instead dependent upon use of the mechanical override mechanism. Transmission of the state signal to the controller unit 31 can be a result of activation of a state switch 90 (see FIG. 9) located on the door 12, the door frame 20, the latch assembly 16, the hinge assembly 18,22, the transponder 56 and/or any other location, such that the state switch 90 is configured to transmit (e.g. wired or wirelessly) the state signal to the controller 31, by example.

It is recognized that when the controller unit 31 is in the first state, a restrict mechanism (not shown), for example a retaining pin, can be enabled by the controller unit 31 to restrict operation of the mechanical override mechanism and thus enforce operation of the latch element 34 as dependent upon actuation by the latch actuator 40 via receipt of the second actuation signal 76.

Alternatively, it is recognized that when the controller unit 31 is in the first state, the restrict mechanism (not shown), for example a retaining pin, can be enabled by the controller unit 31 to restrict operation of the mechanical override mechanism and thus enforce operation of the latch element 34 as dependent upon receipt of the second actuation signal 76 for use by the restrict mechanism, thus disabling the restrict mechanism—for example by the controller unit 31, so as to allow for operation of the mechanical override mechanism to retract the latch element 34 when the transponder 56 is in a predefined vicinity of the receiver 53.

The transponders 56, for example, can be defined as a device that emits the identifying signal 69 (to the controller unit 31) in response to an interrogating received signal 71 (e.g. from transmitter or antenna 70). Alternatively, the transponder 56 can be defined as a remote control device (e.g. RF based remote control) that is used to control operation (e.g. control operation wirelessly from a short line-of-sight distance) of the controller unit 31 from the remote distance using one or more radio signals 69 transmitted by the remote control device, such that the emitted radio signals 69 are not emitted in response to the interrogation signal 71, rather the emitted radio signals 69 can be emitted as a result of the transponder 56 operator pressing a button of the transponder 56.

As such, as a result of the radio signal 69 received from the transponder 56, the controller unit 31 can be programmed to generate and transmit a first actuation signal 74 to the powered actuator 24 and a second actuation signal 76 to the latch actuator 40. The first actuation signal 74 provides for operation of the powered actuator 22 to drive the hinge movement (e.g. relative rotation) of the hinge members 23,28 (see FIG. 3) after the second actuation signal 76 operates the position of the latch element 34 (see FIG. 7) towards the retracted position, wherein the door 12 is operated from the closed position to the open position due to the actuated hinge movement. Alternatively, the first actuation signal 74 provides for operation of the powered actuator 24 to drive the hinge movement before the second actuation signal 76 operates the position of the latch element 34 towards the extended position, whereby the door 12 is operated from the open position to the closed position due to the hinge movement. It is recognized that the operation of the latch element 34 towards the extended position can be biased by a manual mechanism, such as by a biasing element—e.g. spring, rather than automatically by the latch actuator 40 via the second actuation signal 76.

Also in the alternative, the controller 31 can be configured to only transmit the second actuation signal 76 for receipt and subsequent operation of the latch actuator 40, as the hinges used for the door 12 are of the support hinge 18 type. As such, the person using the transponder 56 would be responsible for manually displacing the door 12 from the open to closed position, or from the closed to open position, rather than relying upon automatic actuation of the door 12 movement by an actuated hinge 22 assembly. In this way, the powered actuator 24 is configured to be back driven without use of the first actuation signal 72 when the door 12 is pushed/pulled physically by a person.

In terms of the controller unit 31 itself, the controller unit 31 can include a computer processor 80 and a set of instructions stored in a physical memory 82 for execution by the processor 80 to provide the first actuation signal 74 to the powered actuator 24 and/or the second actuation signal 76 to the latch actuator 40. Further, the controller unit 31 can have a wireless receiver 53 to receive the door operation signal 69 from the wireless transponder 56 in transmission range of the controller unit 31 and in turn generate the first actuation signal 74 and/or the second actuation signal 76 in response.

As such, the controller unit 31 can be configured for operating the door assembly 10 (see FIG. 1a) including the door 12, and optionally the hinge assembly 22 having a pair of hinge members 23,28 for connecting the door 12 to the adjacent door frame 20 and including the hinge actuator 24 for driving relative movement of the hinge members 23,28 with respect to each other. The door assembly 10 also has the latch assembly 16 including the latch element 34 and the latch actuator 40 (see FIG. 7) configured to operate a position of the latch element 34 between the extended position and the retracted position. The controller unit 31 can include the processor 80; the receiver 53 for receiving the door operation signal 69 from the transponder 56; and the set of instructions stored in the physical memory 82 for execution by the processor 80 to: receive the door operation signal 69 from the transponder 56; authenticate that the transponder 56 is registered with the controller unit 31 (e.g. controller/transponder authentication for example using cryptographic authentication as is known in the art); transmit the first actuation signal 72 to the hinge actuator 24 and/or the second actuation signal 74 to the latch actuator 40 in order to cause movement of the latch element 34 to lock/unlock the latch 16 and/or operate the hinge members 23,28 to either displace the door 12 from the closed position to the open position or from the open position to the closed position.

In terms of frequencies of the wireless signals 69, 71, the signaling between the transponders 56 and the transmitters 70 can use a lower frequency (LF) range that that of the signaling between the transponders 56 and the controller unit 31, for example signaling 69 using a UHF radio frequency range. Otherwise, the signaling 71 can use a different set of RF frequencies that the signaling 69.

Further, transmission of the wake-up signal 71 by the transmitters 70 can represent a directionally transmitted wake-up pattern that is configured to activate authorized (e.g. registered with the controller unit 31) within range of a signal 71 localized RF field 73. For example, the transmitter 70 can be located to one side of the door 12 (e.g. inside of a room/building) and thus transmit the signal 71 localized RF field 73 for receipt of transponders 56 located on the same side of the door 12 (e.g. also inside of the room/building). Further, the transmitter 70 can be located to the other side of the door 12 (e.g. outside of the room/building) and thus transmit the signal 71 localized RF field 73 for receipt of transponders 56 located on the same other side of the door 12 (e.g. also outside of the room/building). The use of the directional/localized RF fields 73, one for one side of the door 12 and/or one for the other side of the door 12 can be advantageous for coordinating automatic operation of the door 12 (e.g. hinge actuator 24 and latch actuator 40) only for transponders 56 that are located on the related side of the door 12. Further, the controller 31 can be configured to determine whether the transponder 56 is outside or inside of the door 12 based on a code unique to the transmitter 70 and/or based on signal strength of the signals 71,69.

For example, the controller unit 31 can be programmed to only open the door automatically (i.e. in the presence of a transponder 56 in range of the controller unit receiver 53) when someone is outside of the room and wants to come inside, thus the directional/localized RF field 73 is directed towards the outside (outward facing side of the door 12 with respect to the room/building interior). In this case, if the transponder 56 was located inside of the room/building interior (i.e. adjacent to the inward facing side of the door 12), the transponder 56 would be out of range of the directional/localized RF field 73 (directed towards the outside) and thus would not automatically open the door and allow accidental access to someone without a transponder 56 waiting on the outside of the door 12. Thus only transponders 56 located outside of the room/building are granted automatic access to open the door 12 via the signal 69.

Alternatively, the controller unit 31 can be programmed to only open the door automatically (i.e. in the presence of a transponder 56 in range of the controller unit receiver 53) when someone is inside of the room and wants to go outside, thus the directional/localized RF field 73 is directed towards the inside (inward facing side of the door 12 with respect to the room/building interior). In this case, if the transponder 56 was located outside of the room/building interior (i.e. adjacent to the outward facing side of the door 12), the transponder 56 would be out of range of the directional/localized RF field 73 (directed towards the inside) and thus would not automatically open the door and allow accidental access to someone without a transponder 56 waiting on the inside of the door 12. Thus only transponders 56 located inside of the room/building are granted automatic access to open the door 12 via the signal 69.

In a further embodiment, those transponders 56 that are located to one side of the door 12 can be deactivated (e.g. are not recognized by the controller unit 31). Referring again to FIG. 9, also included can be limit switches 88 that can provide location/position signals 90 to the controller unit 31 to help identify whether the door 12 is open or closed. For example, the door 12 can stop at the predefined limit switch 88 and then can either close after a predefined time or remain open for a predefined time.

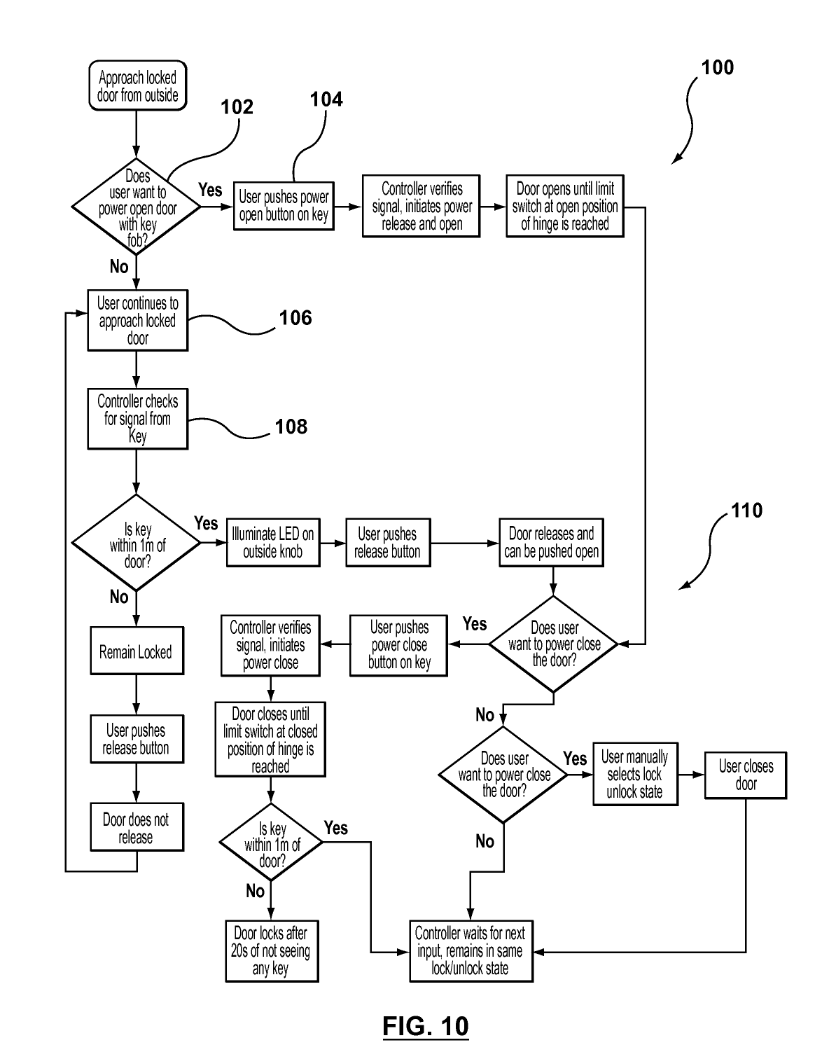

Referring to FIG. 10, shown is an example operation 100 of the door 12 of the door assembly 10 (see FIG. 1a). In particular, step 102 provides for either manual operation of the transponder 56 by pushing of the transponder 56 button at step 104 to operate the latch 16 and/or actuator hinge assembly 22. Alternatively, the user can continue to approach the door at step 106 and the controller unit 31 can check at step 108 for automatic signals 69 emitted by the transponder 56 due to interaction with the signal 71 coming from transmitter 70 that is in range of the transponder 56 (see FIG. 9). Other steps 110 include manual operation of the door 12 once unlatched, manual operation of the latch 16 by depressing the manual button 75, automatic relatching of the latch 16, etc. MANUAL

Referring to FIGS. 9 and 11a,b,c,d, the receiver 53 can be provided in association with the controller unit 31 and can be configured to receive signals 69 from the wireless (e.g. RF) transmitter that is provided in a keyfob/transponder 56 that is carried by a person shown at 58. As the person 58 approaches the door 12 from outside of the building or room (shown at 60) whose access is controlled by the door 12, the transponder 56 can automatically transmit the signal 69 (e.g. an RF signal) to the controller 31 (via receiver 53) that indicates that the person 58 is authorized to enter the building or room 60. In response to the signal 69, the controller unit 31 can operate the latch actuator 40 to retract the latch element 34, thereby permitting the door 12 to be opened by a simple push against it by the person 58 (or in response to operation of the actuated hinge assembly 22). In response to a loss of the signal 69 (e.g. when the transponder 56 is out of range of the receiver 53), the controller 31 can be programmed to extend the latch element 34 so as to latch the door 12. Extending the latch element 34 can simply involve cutting power to the latch actuator 40 so that a spring (not shown) drives the latch element 34 to its extended position. In this way, the transponder 56 causes unlatching and latching of the door 12 passively (i.e. without specific actions carried out by the person 58). In order to conserve battery power on the transponder 56, the transponder 56 may only transmit the signal 69 when it senses that it is within a suitable range of the receiver 53. This can be accomplished for example if the transponder 56 includes a receiver (not shown) to detect a wake-up signal 71 sent by the transmitter 70 that can be coordinated by the controller 31.

In an alternative embodiment, the transponder 56 can be provided with buttons that can be pressed by the person 58 which causes the transmitter of the transponder 56 to send signals 69 that are received by the receiver 53. An ‘unlatch’ signal 76 can be sent to unlatch the door 12 (i.e. to retract the latch element 34) and a ‘latch’ signal 76 can be sent to latch the door 12 (i.e. to extend the latch element 34). The ‘unlatch’ and ‘latch’ signals 76 may be different signals, or they may be the same signal which is interpreted by the controller unit 31 alternately as an ‘unlatch’ signal and then as a ‘latch’ signal. As noted above, in some embodiments the controller unit 31 can latch the door 12 when there is no signal 69 (i.e. when the transponder 56 is out of range of the receiver 53).

In some embodiments, the receiver 53 can also communicate with the controller unit 31. As the person 58 approaches the door 12, the controller unit 31 can, in response to receiving the signal 69 from the transponder 56 (via the receiver 53), open the door 12 using the actuated hinge assembly 22, after the door 12 has been unlatched by the controller unit 31 (FIGS. 11a and 11b). Thus the signal from the transponder 56 can be considered here to be an ‘open’ signal. In response to a loss of signal, the controller unit 31 may close the door 12 prior to the controller unit 31 extending the latch element 34 (FIGS. 11c and 11d). Alternatively, the person 58 may press a suitable button on the transponder 56 to send an ‘open’ signal to cause the controller unit 31 to open the door 12 after it is unlatched and another suitable button (or optionally, the same button) to send a ‘close’ signal to cause the controller unit 31 to close the door 12 prior to extending the latch element 34 to latch and lock the door 12. It will be noted that the ‘close’ signal and the ‘open’ signal may be different signals or they may be the exact same signal which is interpreted by the controller unit 31 alternately as an ‘open’ signal and then as a ‘close’ signal. As noted above, in some embodiments the controller 31 closes the door 12 when there is no signal (i.e. when the transmitter of the transponder 56 is out of range of the controller unit 31).

As shown in FIG. 1b, in some embodiments the door 12 may include an outside visual indicator 62 that indicates whether the door 12 is latched or not. The visual indicator 62 may be on the outside face of the door 12 (shown at 64). In embodiments wherein the door 12 is the door to an office, for example, someone can tell at a glance from a distance if the door 12 is latched, thereby indicating perhaps that the occupant of the office is not there, or is there but does not wish to be disturbed. A similar, inside visual indicator 66 can be provided on the inside face of the door 12 (shown at 68) so that the occupant of the office can see at a glance that the door 12 is latched. Alternatively, the controller unit can be configured to operate the visual indicator 62 (e.g. positioned on the door 12 and/or latch assembly 16 and/or door frame 20—for example, such that the visual indicator 62 is activated by the controller unit 31 in the event of receipt of the door operation signal 69 from the wireless transponder 56 rather than from the manual switch 75. For example, the visual indicator 62 could be activated by the controller 31 so as to represent that the controller unit 31 has sent the second actuation signal 76 to the latch actuator 40 and the door 12 is available for opening by the person (i.e. is “unlocked”). This state of unlocked can be represented as a result that the second actuation signal 76 was processed by the latch actuator 40 to retract the latch element 34 into the retracted position. Alternatively, this state of unlocked can be represented as a result that the second actuation signal 76 was processed by the controller unit 31 to disable the restrict mechanism for the mechanical override mechanism, thus allowing for operation of the mechanical override mechanism to retract the latch element 34 into the retracted position.

In order to prevent injury to persons during opening and closing of the door 12 the controller unit 31 may be configured to detect motor torque from the powered actuator 24 (e.g. by sensing the current draw of the powered actuator 24) so that the controller unit 31 can stop the powered actuator 24 in the event that the powered actuator 24 is driving the door 12 to open or close against a resistance that exceeds a selected threshold.

In view of the above-described system, it is recognized that the transponders 56 can have their own software (e.g. set of operating instructions) to configure optional receipt of the signals 71 and transmission of the signals 69 based on the signals 71 and/or manual operation of transponder 56 buttons, for example. Preferably, there is no programmed instructions in the latch 16 and actuator hinge assembly 22, rather these door assembly 10 components can be controlled from the base station, i.e. the controller unit 31. Further, preferably the signals 90 from the limit switches 88 can go to the controller unit 31. For example, the limit switches 88 can be attached to the door 12.

Referring to FIG. 12, shown is an example flowchart 120 of the instruction set of the controller unit 31. Included by example are steps 122 for polling for any transponders 56 in range of the transmitters 70 by transmitting signals 71 and waiting/listening for receipt of any responding signals 69 sent by the transponders 56 in response to receiving the signals 71 when in range of the RF field 73 (see FIG. 9). Also included are steps 124 to initialize setup and operation of the transmitters 70, including selection of which transmitters 70 to enable or disable based on configuration of the controller unit 31 to either control access through the door 12 for transponders 56 located outside or inside of the room/building. Also included are steps 126 to interpret/decode any signals 69 received by the receiver 53, to generate signal(s) 74,76, and to reinitialize 128 the transmitters 70 for any subsequent transponders 56 coming within range of the RF field 73.

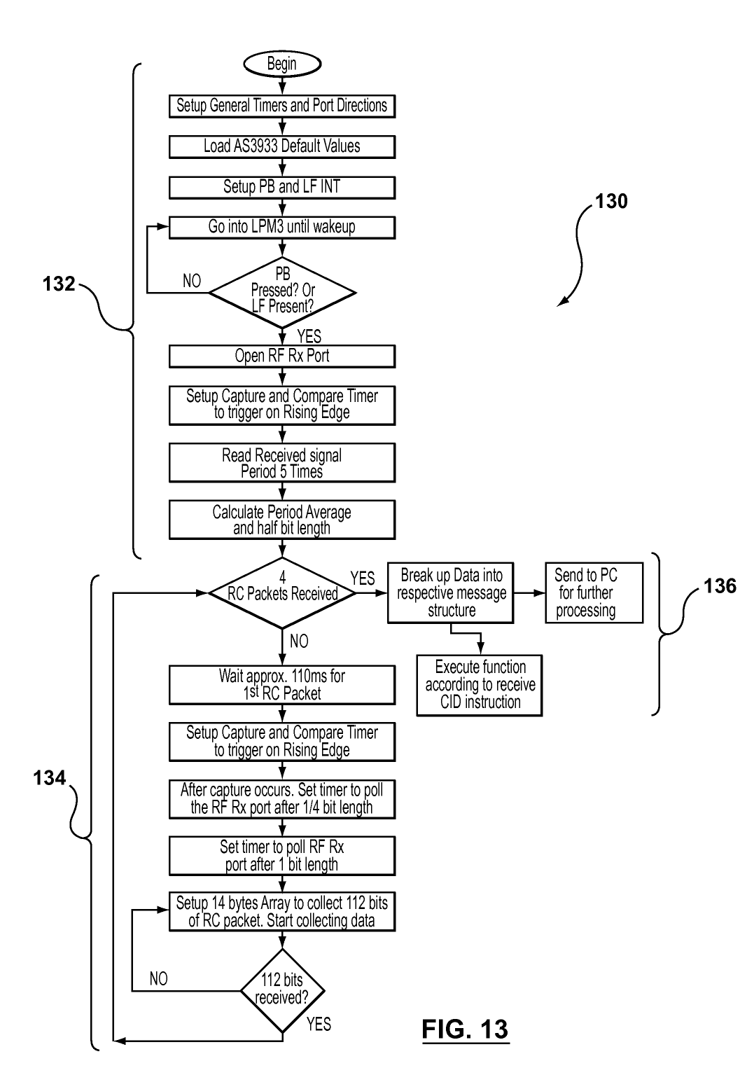

Referring to FIG. 13, shown is an example flowchart 130 of the instruction set of the transponders 56. Included by example are steps 132 for initializing a receiver of the transponder 56 to detect and identify any signals 71 received when in range of the localized RF field 73. Included are steps for confirmation that the received signal 71 is actually signals generated by a valid transmitter 70 based on a minimum number of signal 71 packets received. If some but not all of the minimum number of signal 71 packets have been received, the transponder 5 is configured to wait at steps 134 until the minimum number are received. At steps 136, once the signal 71 is identified as valid, the signal 71 is decoded and the appropriate signal(s) 69 are generated and sent to the controller unit 31.

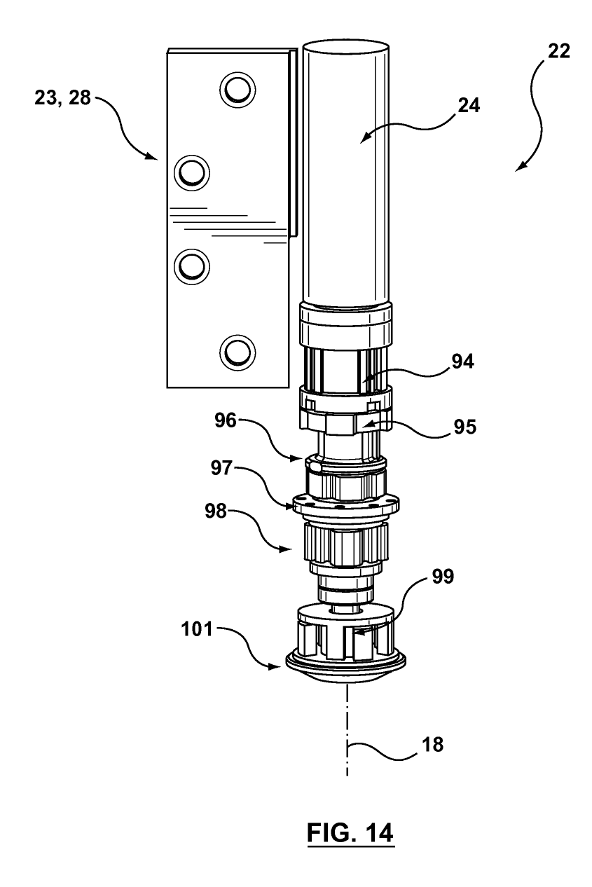

Referring to FIG. 14, shown is another embodiment of the hinge assembly 22 including the powered actuator 24, the hinge members 23,28, the gear set 26 that can be colinear with the axis 18 (e.g. pivot axis) of the hinge members 23,28. It is also recognised that the gear set 26 can be on a gear axis (not shown) that is parallel to the axis 18 but not colinear with the axis 18. As such, the axis of the gear set 26 can be offset from the axis 18 of the hinge members 23,28 (not shown). The gear set 26 can include a number of gear components such as a first gearbox 94, an isolator 95 with slip clutch 96 and cover 97 positioned between the first gearbox 94 and a second gearbox 98. Also included in the hinge assembly 22 can be a coupling 99 with cap 101. It is also recognised that one or more gears of the gear set 26 can be mounted as colinear (e.g. rotational axis of the gear is positioned on the axis 18) with the axis 18 and one or more other gears of the gear set 26 can be mounted off of the axis 18 (e.g. rotational axis of the gear is positioned as offset from the axis 18).

While the above description constitutes a plurality of embodiments of the present invention, it will be appreciated that the present invention is susceptible to further modification and change without departing from the fair meaning of the accompanying claims.

1. An actuated hinge assembly for facilitating pivoting movement of a door, the hinge assembly including:
a first hinge member;
a second hinge member pivotally coupled to the first hinge member;
a powered actuator operatively coupled to the first hinge member, the actuator configured to drive relative rotation of the first hinge member and the second hinge member with respect to each other;
wherein one hinge of the first hinge member and the second hinge member is configured for mounting to the door and the other of the first hinge member and the second hinge member is configured for mounting to a door frame of the door.

2. The actuated hinge assembly of claim 1, wherein the first hinge member is configured for mounting to the door frame.

3. The actuated hinge assembly of claim 2 further comprising the first hinge member having a power conduit connected to the powered actuator, the power conduit configured for coupling to an external power source located off of the door and adjacent to the door frame.

4. The actuated hinge assembly of claim 2 further comprising the hinge assembly attached to the door by the second hinge member, such that the hinge assembly and the door are provided as a door assembly.

5. The actuated hinge assembly of claim 2 further comprising a sleeve portion of the second hinge member that slides over a housing portion of the first hinge member, whereby a pivot axis of the first hinge member is collinear with a pivot axis of the second hinge member.

6. The actuated hinge assembly of claim 1, wherein the first hinge member is mounted to the door, such that the hinge assembly and the door are provided as a door assembly.

7. The actuated hinge assembly of claim 6 further comprising the first hinge member having a power conduit connected to the powered actuator, the power conduit configured for coupling to an external power source located off of the door and adjacent to the door frame.

8. The actuated hinge assembly of claim-6 further comprising the second hinge configured for mounting to the door frame.

9. The actuated hinge assembly of claim 8 further comprising the second hinge having a passageway for directing the power conduit into the door frame.

10. The actuated hinge assembly of claim 1 further comprising a gear set that is driven by the powered actuator, the gear set connected to the second hinge member.

11. The actuated hinge assembly of claim 10, wherein the powered actuator is an electric motor.

12. The actuated hinge assembly of claim 10, wherein the gear set when driven provides output torque applied to the second hinge member, such that the output torque is collinear with a pivot axis of the second hinge member.

13. The actuated hinge assembly of claim 10, wherein the gear set is a planetary gear set.

14. The actuated hinge assembly of claim 3 further comprising the hinge assembly attached to the door, the door having a door latch including a latching element and a latch actuator configured to operate a position of the latch element between an extended position and a retracted position, wherein the latching element when in the extended position is configured to be received by a receptacle in the door frame to retain the door in a closed position, such that the hinge assembly and the door latch and the door are provided as a door assembly.

15. The actuated hinge assembly of claim 14 further comprising a controller unit including a processor and a set of instructions stored in a physical memory for execution by the processor to: provide a second actuation signal to the latch actuator.

16. The actuated hinge assembly of claim 15, wherein a first actuation signal provides for operation of the powered actuator to drive said relative rotation after the second actuation signal operates the position of the latch element towards the retracted position, wherein the door is operated from the closed position to an open position due to said relative rotation.

17. The actuated hinge assembly of claim 15, wherein a first actuation signal provides for operation of the powered actuator to drive said relative rotation and a spring mechanism is used to operate the position of the latch element towards the extended position rather than the second actuation signal, wherein the door is operated from an open position to the closed position due to said relative rotation.

18. The actuated hinge assembly of claim 15 further comprising the controller unit having a wireless receiver, the set of instructions for execution by the processor to: receive a door operation signal by the wireless receiver from a wireless transponder in transmission range of the controller unit; and generate the second actuation signal in response.

19. The actuated hinge assembly of claim 7 further comprising the hinge assembly attached to the door, the door having a door latch including a latching element and a latch actuator configured to operate a position of the latch element between an extended position and a retracted position, wherein the latching element when in the extended position is configured to be received by a receptacle in the door frame to retain the door in a closed position, such that the hinge assembly and the door latch and the door are provided as a door assembly.

20. The actuated hinge assembly of claim 19 further comprising a controller unit including a processor and a set of instructions for execution by the processor to: provide a second actuation signal to the latch actuator.

21-51. (canceled)
